(19) United States
(12) Patent Application Publication
(10) Pub. No.: US 2026/0025740 A1
(43) Pub. Date: Jan. 22, 2026

(54) Multiple Radios Per Node Network Architecture (MRNNA)

(71) Applicant: The United States of America, as represented by the Secretary of the Navy, Arlington, VA (US)

(72) Inventors: Christopher Corbin Cirullo, San Diego, CA (US); Randall Bruce Olsen, Carlsbad, CA (US); Robert Ferro, San Diego, CA (US); Jia-chi Sam Chieh, San Diego, CA (US); Joonyoung Yu, San Diego, CA (US); Nathaniel Ray Stevens, Bremerton, WA (US); Kyle A. Bales, La Mesa, CA (US)

(21) Appl. No.: 18/780,276

(22) Filed: Jul. 22, 2024

(51) Int. Cl. H04W 48/16; H04L 41/12; H04W 84/18

(52) U.S. Cl. CPC H04W 48/16; H04L 41/12; H04W 84/18

(57) ABSTRACT

A wireless mesh network node comprising: a plurality of radios mounted on a platform, wherein each of the plurality of radios is a complete, stand-alone, unmodified radio lacking only an antenna; a plurality of directional antennas mounted on the platform, wherein each of the plurality of antennas is communicatively connected to a corresponding radio of the plurality of radios, wherein a combination of an antenna and its corresponding radio is referred to as a sector; and a master controller mounted to the platform and operatively connected to the sectors, wherein the wireless mesh network node is configured to discover remote neighbor nodes by having each sector perform a zone-limited search of a surrounding area without the use of an omnidirectional or broadbeam antenna, and wherein the master controller is configured to receive, from the sectors, link-state information and geo-location information of the remote neighbor nodes.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 211615.

### BACKGROUND OF THE INVENTION

It is well known that the use of high gain electronically-steerable directional antennas enhances the performance of wireless networks. The benefits include longer range, higher data rates, and spatial reuse, to name a few. However, the use of such directional antennas in dynamic mobile environments introduces numerous problems at many layers of the network protocol stack. Standard network protocols and algorithms such as neighbor discovery, media access control (MAC), routing, and quality of service (QOS) that have been optimized for wired, omni-directional and/or fixed terrestrial networks do not consider the additional degree of freedom/search space of using directional antennas. Uncoordinated beam steering disrupts the standard functions of these surrounding protocol layers and therefore produces unstable and substantially less than optimal performing networks.

Some prior art topologies require complex scheduling and protocol development. A wireless network link is the logical connection between two or more radio devices in a network, existing at both the MAC and routing layers. To establish a link, the protocols perform a handshake process by exchanging authentication and association information. The connection status of a link is up when channel conditions are favorable for successful transmission and reception, and down otherwise. The quality of a link varies over time and can be assessed using metrics like received signal strength indicator (RSSI), bit error rate (BER), data rate, and signal-to-interference and noise ratio (SINR). External factors that affect link quality such as intentional jamming, interference, and environmental conditions such as multi-path fading, rain, and fog are outside the control of the system. Directional antennas, when correctly aligned, can enhance link quality by overcoming external conditions. However, if misaligned, link quality deteriorates, leading to weak and intermittent connectivity. Thus, some disruptions are self-inflicted due to improper antenna alignment. Such a self-inflicted link disruption may be referred to as a “link continuity break.” In some architectures and some topologies, a radio and an antenna are forced to support multiple links by time sharing. These “shared links” suffer from self-inflicted continuity breaks, leading to unpredictable performance issues determined by the network protocols' response.

The true effect of faults, errors, and failures on protocols are hard to estimate due to the complexity of protocols, use cases, and environmental conditions. It is good to have a general understanding of the timescales and sensitivities of each protocol layer. The MAC layer is the most sensitive as it operates on micro-second or milli-second time scales and implements coordinated channel access and rate adaptation functions. Routing layers send control packets every few seconds to discover direct neighbors and learn available network paths. Quality of Service schedules packet queues to minimize delay for critical time sensitive applications. The TCP protocol uses a windowing mechanism to balance maximizing throughput and avoiding network congestion. Self-inflicted continuity breaks will be detected by one or more of these protocols and will result in degraded performance or protocol failure.

The stability and quality of the links in turn influence how protocols sense and interact with the environment. Network protocols rely on strong and stable link quality to function correctly, and they are continuously sensing link state to adapt to physical layer conditions. A resilience concept that comes into play when examining the interaction between link quality and network protocols is the fault, error, failure chain. Faults are flaws in system design that can lead to errors. For example, an architecture with a design flaw requires “shared links” which suffer self-inflicted continuity breaks that can trigger packet reception errors and/or protocol errors. An accumulation of errors or errors on critical control packets may result in failures at multiple levels that cascade up the protocol stack. For example, the transport control protocol (TCP) uses a three-way handshake to create sockets to manage a session between remote nodes. If these critical control packets are dropped due to reception errors, a service failure occurs because the applications cannot exchange data. Similarly, dropped critical control packets at the routing layer can cause routing failures, preventing routers from discovering neighbors and finding valid network paths. There is a need for an improved directional antenna wireless network.

### SUMMARY

Described herein is a wireless mesh network node comprising a plurality of radios, a plurality of directional antennas, and a master controller. The plurality of radios is mounted on a platform. Each of the plurality of radios is a complete, stand-alone, unmodified radio lacking only an antenna. The plurality of directional antennas is mounted on the platform. Each of the plurality of antennas is communicatively connected to a corresponding radio of the plurality of radios. Each combination of an antenna and its corresponding radio is referred to as a sector. The master controller is mounted to the platform and operatively connected to the sectors. The wireless mesh network node is configured to discover remote neighbor nodes by having each sector perform a zone-limited search of a surrounding area without the use of an omnidirectional or broadbeam antenna. The master controller is configured to receive, from the sectors, link-state information and geo-location information of the remote neighbor nodes.

Also described herein is a method for establishing a wireless mesh network comprising the following steps. The first step involves providing a plurality of nodes. Each node comprises N sectors communicatively connected to a node-specific master controller. Each sector comprises a radio connected to a directional antenna. Another step provides for discovering, with each sector, without the use of an omnidirectional or broadbeam antenna, remote sectors from remote neighbor nodes that are in view of each sector's associated directional antenna. Another step provides for receiving at each given node, from the given node's sectors, link-state information and geo-location information of the remote neighbor nodes. Another step provides for calculating at each node a topology of the wireless mesh network based on the link-state information and geo-location information. Another step provides for determining, based on the topology and a predefined ruleset, a pair of sectors to establish a quasi-dedicated link between. The sectors in the pair of sectors are mounted to different platforms. Another step provides for establishing and maintaining a quasi-dedicated link between the pair of sectors for at least sixty seconds.

### BRIEF DESCRIPTION OF THE DRAWINGS

Throughout the several views, like elements are referenced using like references. The elements in the figures are not drawn to scale and some dimensions are exaggerated for clarity.

FIG. 1 is a block diagram of a single node of a wireless mesh network.

FIG. 2 is a depiction of an example embodiment of a wireless mesh network.

FIG. 3 is a top-view illustration of two network nodes mounted on separate ship platforms.

FIG. 4 is a top-view illustration of an embodiment of a wireless mesh network.

FIGS. 5A, 5B, 5C, 5D, 5E, and 5F are representations of a prior art fully-connected three-node network.

FIGS. 6A, 6B, 6C, and 6D are illustrations of a seven-node network with different sector architectures.

FIG. 7 is a graph.

FIG. 8 is an illustration of an embodiment of a MRNNA node.

FIG. 9 is a flowchart.

FIG. 10 is a diagram of an embodiment of a wireless mesh network.

FIG. 11 is a schematic view of another embodiment of a MRNNA node.

FIG. 12 is an illustration of an embodiment of a MRNNA network.

### DETAILED DESCRIPTION OF EMBODIMENTS

The disclosed networks and networking methods below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

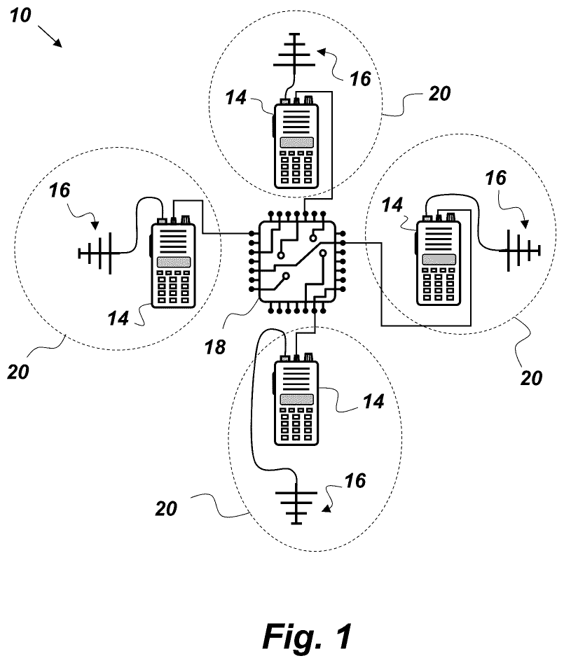

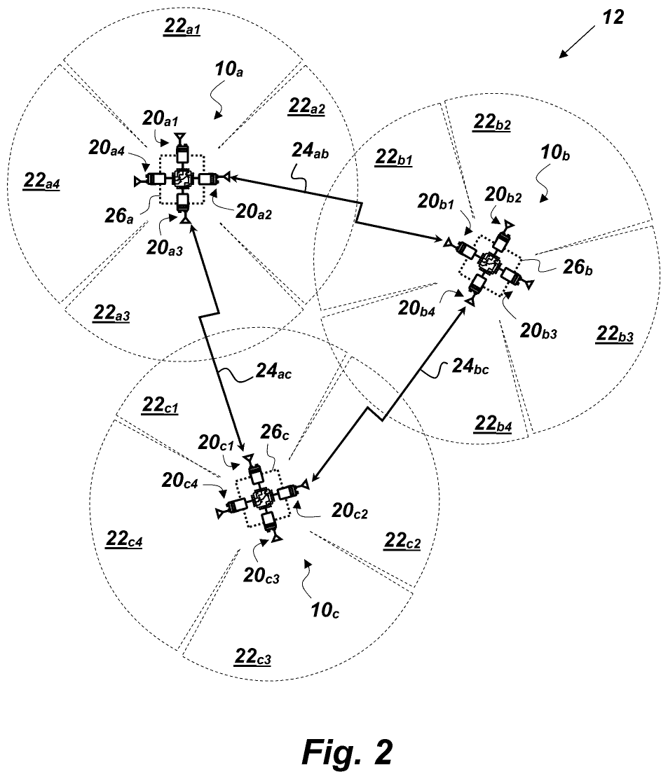

FIG. 1 is a block diagram of a node having a multiple-radio-per-node network architecture (MRNNA) (hereinafter referred to as MRNNA node 10) of a wireless mesh network (hereinafter referred to as MRNNA network 12). An example of the MRNNA network 12 is shown in FIG. 2. MRNNA node 10 comprises, consists of, or consists essentially of a plurality of radios 14, a plurality of directional antennas 16, and a master controller 18. Each radio 14 is a complete, stand-alone, unmodified radio lacking only an antenna. Each directional antenna 16 is communicatively connected to a corresponding radio 14. Each combination of a directional antenna 16 and its corresponding radio 14 is referred to as a sector 20. The master controller 18 is operatively connected to the sectors 20 of the MRNNA node 10.

The master controller 18 for a given MRNNA node 10 may be any logic circuit or software running on a computer capable of managing the respective operating frequencies of the sectors 20 of the given MRNNA node 10 as well as directing which radios 14 and which directional antennas 16 of the given MRNNA node 10 to use to establish links with neighboring nodes 10 in the MRNNA network 12. The master controller 18 may be connected the sectors 20 via an Ethernet connection. Suitable examples of the master controller 18 include, but are not limited to, a computer, a logic circuit, and a field programmable gate array.

Each radio 14 may be any radio capable of supporting a communications link. Each MRNNA node 10 is substantially radio agnostic. In other words, the radios 14 may selected from a wide variety of radios. Suitable examples of the radio 14 include, but are not limited to, commercial radios such as WiFi or WiMax, Cellphone radios such as LTE and 5G, military radios such at CDL (common data link) and many others. Each radio 14 may be configured to use an unmodified, original MAC protocol associated with each radio. One specific, non-limiting, suitable example of a radio that may be used as a radio 14 is the Swiss Army Knife radio manufactured by Ubiquiti Inc., which is currently based in New York, NY.

The directional antennas 16 may be any antenna capable of being steered (either electronically or mechanically) or focused over some field of view. For example, for a MRNNA node 10 with six sectors 20, each sector may be assigned a 60-degree field of view. Suitable examples of ways to steer each directional antenna 16 include, but are not limited to, phased arrays, frequency steering, and photonic feed networks. Preferably, each MRNNA antenna should be a high gain antenna (i.e., with a beam width of about 20 degrees or less). The use of quasi-dedicated links 24 in the MRNNA network 12 enables the use of mechanically steered antennas (which are not typically able to be used in networks involving directional antennas) since high-speed beam switching is not required by MRNNA nodes 10. Mechanically steered antennas can have advantages over phased arrays, including lower cost, higher bandwidth, and higher wall-plug-to-RF-power efficiency. Depending on the application, any one of these can be a deciding factor in favor of mechanical antennas over phased arrays. In another example, each directional antenna 16 in the MRNNA network 12 may be an electronically steerable antenna with a beamwidth of less than twenty degrees. Wifi includes a wide variety of 802.11 wireless local area network (LAN) standard compliant radios including 802.11b, 802.11a, 802.11g, 802.11n, 802.11ac, 802.11ad, 802.11ax or newer IEEE standards compliant digital radios, which are all suitable examples of the radio 14. A specific, suitable, non-limiting example of a directional radio 16 is the UACC-UK-Ultra-Panel-antenna, manufactured by Ubiquiti, which is a very simple antenna, which creates a ninety-degree wide beam that is not steerable, but may be used as a directional antenna 16. FIG. 2 is a top-view depiction of an example embodiment of the MRNNA network 12 consisting of three MRNNA nodes 10ₐ, 10_{b}, and 10_{c}. Each MRNNA node 10 is configured to discover remote neighbor MRNNA nodes 10 by having each sector 20 perform a zone-limited search of a surrounding area without the use of an omnidirectional or broadbeam antenna. The zone-limited search of the surrounding area may involve each sector 20 searching a separate corresponding zone 22. The master controller 18 is configured to receive, from the sectors 20, link-state information and geo-location information of the remote neighbor MRNNA nodes. For example, in FIG. 2, each of the constituent sectors 20 of each of the MRNNA nodes 10ₐ, 10_{b}, and 10_{c} is configured to have a view of a separate zone 22. Each zone 22 represents an area that is searchable or within view of a corresponding sector 20; and each zone 22 may be defined by a circular sector having a radius equivalent to a radio frequency (RF) transmission distance, or line of sight (LOS), of the corresponding sector 20. The four directional antennas 16 shown for MRNNA nodes 10ₐ, 10_{b}, and 10_{c} are respectively mounted circumferentially to four platforms 26ₐ, 26_{b}, and 26_{c} in a plane that is orthogonal to a gravity vector. The four directional antennas 16 may be spaced apart from each other on the platform 26 to a maximum extent practicable or as desired.

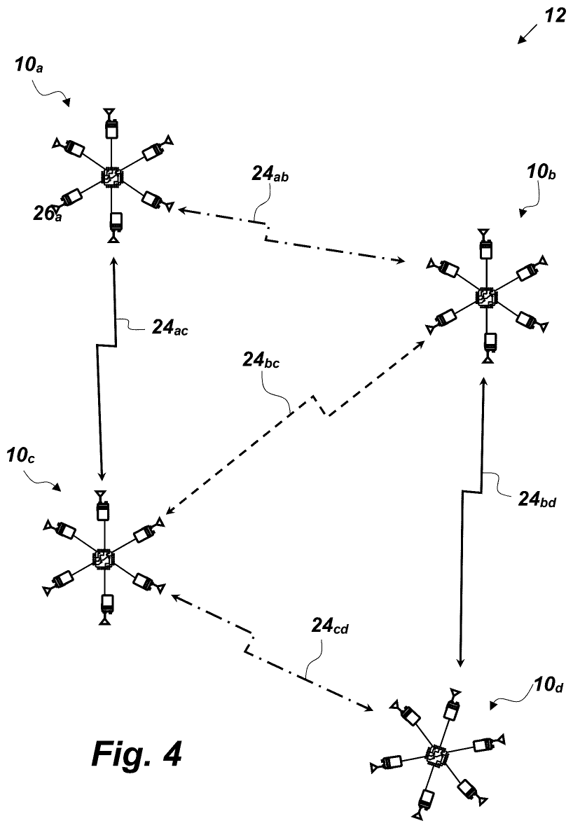

The zones 22 depicted in FIG. 2 are not drawn to scale for ease of illustration. To explain, even though it appears otherwise, in FIG. 2, MRNNA node 10; lies within zones 22ₐ₂ and 22_{c2}; MRNNA node 10_{c} lies within zones 22_{b4} and 22ₐ₃; and MRNNA node 10ₐ lies within zones 22_{c1} and 22_{b1}. In FIG. 2, a quasi-dedicated link 24_{ab} is shown as being established between sectors 20ₐ₂ and 20_{b1}; a quasi-dedicated link 24_{bc} is shown as being established between sectors 20_{b4} and 20_{c2}; and a quasi-dedicated link 24_{ac} is shown as being established between sectors 20ₐ₃ and 20_{c1}. As used herein, the term “quasi-dedicated” describes links that are maintained on the timescale of seconds to minutes (i.e., links that are maintained for at least a second). This avoids the problems of trying to work at the millisecond to microsecond time scale of MACs and is compatible with node mobility patterns and routing update timescales. The separate zones 22 of a given MRNNA node 10 may be designated so as to not overlap, or only overlap minimally, with each other such that each sector 20 of each MRNNA node 10 is configured to perform a unique, zone-limited search of a surrounding area. In some embodiments, it may be desirable for the zones 22 of a particular MRNNA node 10 to cover the entire 360-degree horizontal search space around the MRNNA node 10. Each MRNNA node 10 shown in FIG. 2 is mounted to a separate platform 26. The master controller 18 of a local MRNNA node 10 may be configured to establish a quasi-dedicated point-to-point link 24 between a pair of sectors 20 (i.e., one sector from the local node and the other sector from a neighbor node) when channel conditions are favorable for successful transmission and reception between the pair of sectors 20. While the quasi-dedicated point-to-point link 24 is established between a pair of sectors 20, the sectors in that pair of sectors 20 are not linked to any other sectors 20. Once a quasi-dedicated point-to-point link 24 is established between the pair of sectors, the corresponding master controllers 18 may be configured to maintain the quasi-dedicated point-to-point link 24 for at least one second such that the master controllers 18 do not need to coordinate beam steering operations with routing, quality of service (QOS), and MAC protocols. Each radio 14 of a corresponding MRNNA node 10 may be configured to use unmodified, original QoS and MAC protocols associated with each radio 14. In other words, no changes need to be made to the MAC and QoS layers for the radio 14 to be used in the MRNNA network 12. In one example embodiment, the master controllers 18 associated with a given quasi-dedicated link 24 between a pair of sectors 20 may be configured to maintain the quasi-dedicated point-to-point link 24 for at least sixty seconds. Each quasi-dedicated link 24 may be established such that there is a one-to-one relationship between the paired sectors 20 by isolating the paired sectors 20 from the rest of the MRNNA network 12 using frequency assignment (such as shown in FIG. 4), antenna pointing direction, and data link layer configuration.

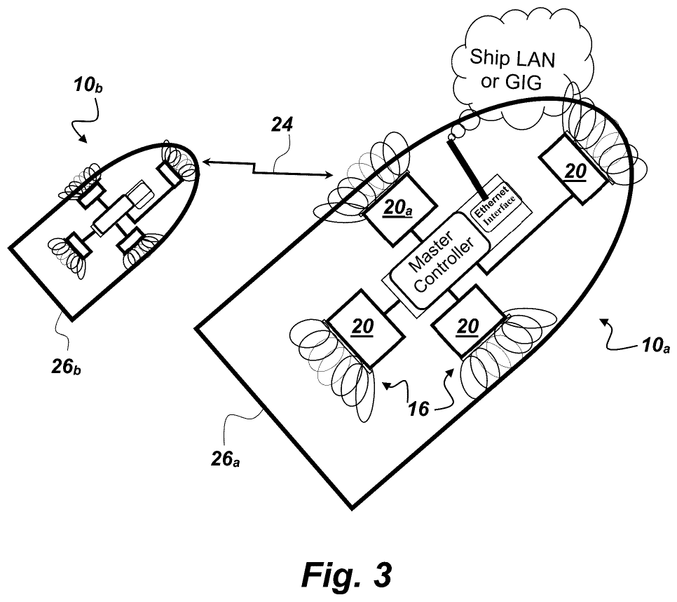

FIG. 3 is a top-view illustration of two MRNNA nodes 10 mounted on separate ship platforms 26. The platform 26 can be a mobile platform (e.g. a ship, plane, ground vehicle etc.) or literally a fixed platform (e.g. a building, antenna tower, other structure, etc.). Suitable examples of the platform 26 include, but are not limited to, a tower, a ship, a ground vehicle, an aircraft, a spacecraft, and a man-portable pack. For a MRNNA node 10 on a terrestrial platform (i.e., on the surface of the earth, on a water surface, or in the air above the earth) communicating with another terrestrial MRNNA node 10, a directional discovery process can be collapsed from a four-dimensional search to a two-dimensional search. This is true because the occupiable volume of the entire search space is similar to the shape of a pancake. While the atmosphere is only about 9.6 kilometers (six miles) thick (for most aircraft), the curvature of earth-limited-LOS distances can be hundreds of miles, depending on altitude. Furthermore, for the case of a MRNNA node 10 with N sectors 20, the search space becomes even smaller due to the number of sectors 20. For example, for the case where each MRNNA node 10 has four sectors (i.e., where N=4) (such as each of MRNNA nodes 10ₐ and 10_{b} shown in FIG. 3), each sector 20 only needs to search over 90 degrees (which is 360 degrees of total azimuthal angle divided by four sectors). In the case of a 90-degree search zone 22, if a given directional antenna 16 is an electronically-steerable antenna with a beamwidth of ten degrees, only nine different beamwidths would need to be searched by the corresponding sector 20 to cover the 90-degree search zone 22. Such may be considered a one-dimensional search space of a first sector, such as sector 20ₐ shown in FIG. 3. Still referring to FIG. 3, there is another one-dimensional search space for MRNNA node 10_{b}, which also has four sectors 20 of the same size. The total two-dimension search space is simply the product of the two one-dimensional spaces or just 81. If the time to search a given pair of beam angles is 100 milliseconds, a random search can take just 8.1 seconds. For the N=6 case, such as shown in FIG. 4, each sector 20 only needs to search over 60 degrees and a similar search can take just 3.6 seconds.

FIG. 4 is a top-view illustration of another embodiment of the MRNNA network 12 where N=6 for each of the four MRNNA nodes 10. The six directional antennas 16 for each MRNNA node 10 shown in FIG. 4 may be mounted circumferentially to corresponding platforms 24 (such as shown in FIGS. 2 and 3) in a plane that is orthogonal to a gravity vector. Quasi-dedicated links 24_{ab} and 24_{cd} use a first frequency, quasi-dedicated links 24_{ac} and 24_{bd} use a second frequency, and quasi-dedicated link 24_{bc} uses a third frequency. Multiple-radio architectures with directional antennas enhance resilience of the MRNNA network 12 through simplicity, which is achieved by link stabilization, eliminating the need for link scheduling, and reducing protocol interactions between layers of the network stack. Self-inflicted continuity breaks represent unnatural variability and can be avoided by choosing architectures without design flaws such as the six-sector directional architecture shown in FIG. 4. Each of the sectors 20 on a given MRNNA node 10 may be configured to transmit and receive on a different frequency from the other sectors 20 on the given MRNNA node 10 as dynamically determined by the corresponding master controller 18. This allows concurrent communication between the given MRNNA node 10 and several remote neighbor MRNNA nodes 10.

Temporary self-inflicted link disruptions will have some complex and difficult to predict detrimental effects on MAC, Router, QoS, and transport layer protocols. Shared links are the source of self-inflicted continuity breaks which cause detrimental effects to network protocols and add complexity to the entire network through the need for scheduling link activation. Architecture significantly influences the need for shared links as the network scales to larger numbers of nodes. For example, one-sector architectures (i.e., where N=1) require link sharing even in networks as small as three nodes, and increasing in complexity as the network grows. Adding a second sector per node eliminates link sharing in a three-node network but requires shared links as the network expands beyond three nodes. As the number of sectors per node increases, the need for link sharing and scheduling decreases, disappearing entirely with six or more sectors per node. In graph theory the degree of a node is the number of links it has. The maximum degree of any node in the network is less than six, so using six sectors per node eliminates the need for link sharing. The four-sector design of the MRNNA node 10 (e.g., FIGS. 1 and 2) has a low link-sharing requirement, achieving over 95% connectivity, though some scenarios may still require link sharing to maintain connectivity.

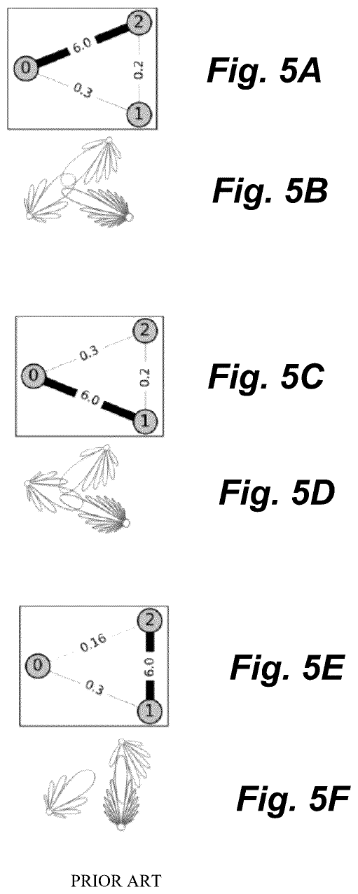

FIGS. 5A, 5B, 5C, 5D, 5E, and 5F are representations of a prior art fully-connected three-node network where each node has a single sector that uses a phased array antenna, and where each sector must support two links. FIGS. 5A, 5B, 5C, 5D, 5E, and 5F show how shared links force link connectivity breaks and require scheduling. Links in the non-activated state may connect on antenna side lobes with reduced link quality. FIGS. 5A and 5B represent the three-node network at a first time slot where a link is active between Node 0 and Node 2. FIGS. 5C and 5D represent the three-node network at a second time where a link is active between Node 0 and Node 1. FIGS. 5E and 5F represent the three-node network at a third time where a link is active between Node 2 and Node 1.

For each architecture, a degree sequencing ratio can be used to assess the need for link sharing by dividing each node degree by the number of sectors per node. The degree of a node is the number of links it has. For example, each node in the three-node network shown in FIG. 5A would have a degree of two since each node has two links. A degree sequence lists all the node degrees in the network divided by the number of sectors per node. For example, the three-node network shown in FIG. 5A with its one-sector architecture (i.e., where N=1) would have a degree sequence of (2/1, 2/1, 2/1). In another example, a five-node network having a one-sector architecture with a degree sequence (4, 3, 3, 1, 1) becomes (4/2, 3/2, 3/2, 1/2, 1/2) for a two-sector-per-node architecture and (4/6, 3/6, 3/6, 1/6, 1/6) for a six-sector-per-node architecture. Values greater than one indicate that shared links are required to support a topology. The degree sequence view of the network also highlights the relationship between architecture, topology control, and link scheduling.

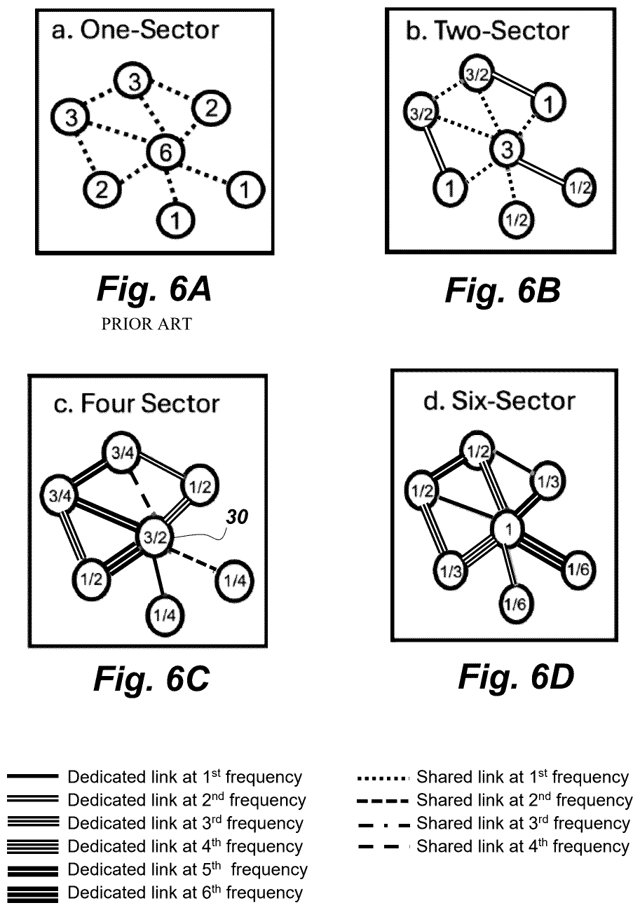

FIGS. 6A, 6B, 6C, and 6D are illustrations of a seven-node network with different sector architectures. FIGS. 6A, 6B, 6C, and 6D show the frequency assignment and link scheduling requirement for different architectures supporting the same seven-node topology. Dashed lines represent shared links. FIG. 6A illustrates a prior art one-sector architecture where all links are shared and operate on the same frequency. FIG. 6B illustrates a two-sector architecture where not all links are shared. FIG. 6C illustrates a four-sector architecture where the middle node 28 must share links to manage six links with four sectors. FIG. 6D illustrates a six-sector architecture where there are no shared links and four different frequencies are used to simultaneously support eight quasi-dedicated links such that every node is connected to the network with a quasi-dedicated link 24.

Network topology control can be an important aspect of directional mobile wireless networks (MWNs) and may be used for managing the structure and connectivity of the network. One of the primary functions of topology control is link selection, which involves determining which links should be established from the set of all possible connections. Topologies can be evaluated based on structural properties such as k-connectivity or identifying articulation points and bridges. An articulation point in a network is a node whose removal disconnects the network. These structural properties are related to resilience as they indicate the level of redundancy in a network. It can be important to consider non-structural factors that improve link quality and link continuity to ensure stable connections that support protocol interactions. Architecture influences the ability of a network node to support certain topologies and is a key factor that determines whether link sharing and scheduling is required.

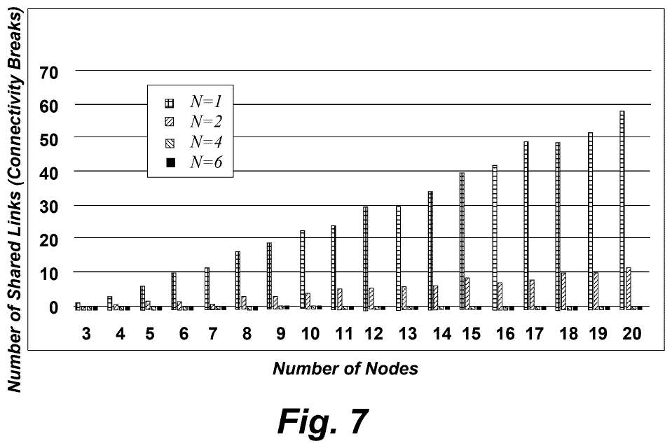

FIG. 7 is a graph showing the number of shared links required for four different architectures (i.e., where N=1, N=2, N=4, and N=6). Shared links in the one-sector architecture grow at a much faster rate than two-sector architecture and shared links are not required for the four-sector and the six-sector architectures. Shared links require a time-sharing schedule to allocate time slots for directional antennas to support each link. When a specific link is activated, it is desirable that antennas on both ends of the link are optimally pointed to maximize the link's quality. When that specific link is deactivated, the antenna services a different link, causing a self-inflicted continuity break for the inactive specific link. Scheduling may be addressed as a flow optimization linear programming problem or a graph edge coloring problem. There is no precedent for quantifying the complexity or simplicity of a directional MWN. However, complexity may be considered as the product of link scheduling and the interaction between network protocols. Scheduling links adds complexity to a network because link schedules must be computed globally and schedule execution requires precise timing for all antennas to switch links correctly. The link disruptions that occur as a result of switching between shared links further disrupts and complicates the interactions between protocols. Counting the number of shared links as the network grows may be used as a measure or indication of simplicity and is related inversely with simplicity.

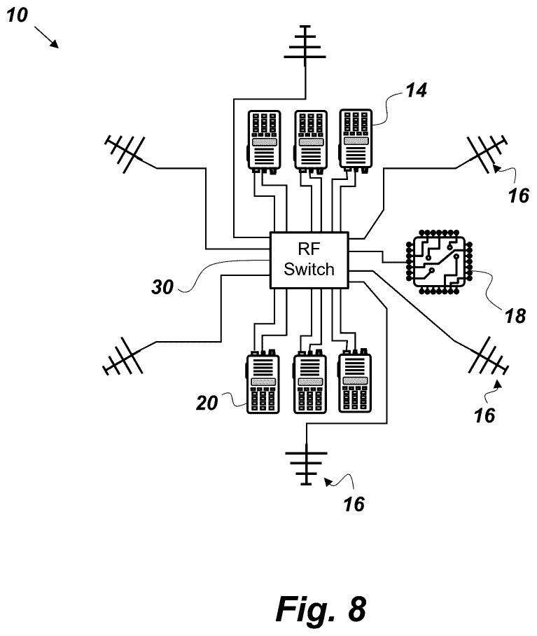

FIG. 8 is an illustration of an embodiment of the MRNNA node 10 further comprising an RF switch 30 mounted to the platform 26 and communicatively coupled between the plurality of radios 14 and the plurality of directional antennas 16 such that the RF switch 30 is capable of dynamically controlling which radio 14 is connected to which directional antenna 16. The master controller may be configured to determine a given radio 14, a given directional antenna 16, and a given frequency to be used for communicating with a given remote neighbor MRNNA node 10. The master controller 18 may be configured to use the RF switch 30 to handle relative orientation changes between two MRNNA nodes 10 in a MRNNA network 12 (such as depicted in FIG. 4). For example, if a platform 26 on which a given MRNNA node 10 is mounted rotates with respect to the other MRNNA nodes 10 in the MRNNA network 12, the RF switch 30 may be used to provide a physical switching capability between the given node's radios 14 and the given node's directional antennas 16. This can happen if a given platform 26 (e.g., ship, aircraft, or car) executes a turn for example. The physical connection between a given radio 14 and any of the directional antennas 16 on a given MRNNA node 10 can be dynamically established with the RF switch 30. This addresses the well-known “handover” and topology control problems in WRNs.

Handover occurs when the positioning of MRNNA nodes 10 changes sufficiently to require that one of the radios 14 breaks the connection and establishes a new connection with another radio 14 in the network 12. In multiple-radio architectures a handover may be required when the local node rotates or moves some distance with respect to a neighbor MRNNA node 10. The RF switch 30 of a local MRNNA node 10 may function as a rotor and allow the local MRNNA node 10 to rotate freely while maintaining the original link between one of the local MRNNA node 10's radios 14 and a radio 14 of a remote MRNNA note 10. It is also true that an RF switch 30 can serve the same function for multiple radios 14 on a local MRNNA node 10 connected to multiple other radios 14 on other MRNNA nodes 10. The RF switch 30 eliminates the requirement for handover and special network protocol changes.

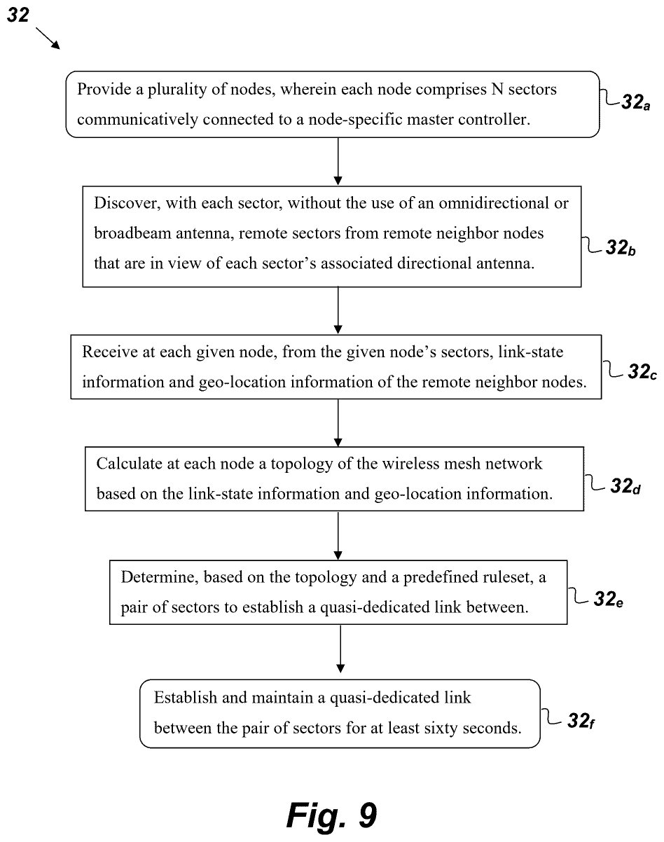

FIG. 9 is a flowchart of a MRNNA method 32 for establishing the MRNNA network 12. MRNNA method 32 may comprise, consist of, or consist essentially of the following steps. A first step 32ₐ involves providing a plurality of nodes, wherein each node comprises N sectors communicatively connected to a node-specific master controller. Each sector comprises a radio connected to a directional antenna. Another step 32_{b} provides for discovering, with each sector, without the use of an omnidirectional or broadbeam antenna, remote sectors from remote neighbor nodes that are in view of each sector's associated directional antenna. Another step 32_{c} provides for receiving at each given node, from the given node's sectors, link-state information and geo-location information of the remote neighbor nodes. Another step 32ₐ provides for calculating at each node a topology of the wireless mesh network based on the link-state information and geo-location information. Another step 32ₑ provides for determining, based on the topology and a predefined ruleset, a pair of sectors to establish a quasi-dedicated link between. The sectors in the pair of sectors are mounted to different platforms. Another step 32_{f} provides for establishing and maintaining a quasi-dedicated link between the pair of sectors for at least sixty seconds.

Once a quasi-dedicated link has been established between a pair of sectors, MRNNA method 32 may further include continuing to discover remote neighbor nodes with the sectors that are not part of any quasi-dedicated link. The master controller associated with each node may be used to dynamically determine a frequency for transmitting and receiving at each sector of its associated node. In this way, concurrent communication is enabled between a single node and multiple other remote neighbor nodes via multiple quasi-dedicated links (such as is portrayed in FIG. 4).

Unlike many cellular wireless networks which have the luxury of fixed infrastructure, many wireless networks often are required to be of an ad hoc nature. These mobile ad hoc wireless networks suffer from a well know scaling challenge. Spatial-reuse and high data rate capability can be both obtained by using narrow beam (high gain) directional antennas in a directional wireless network (DWN) such as may be done with MRNNA method 32. Mobility requirements can be satisfied if the directional antennas are electronically-steerable or steerable by other means.

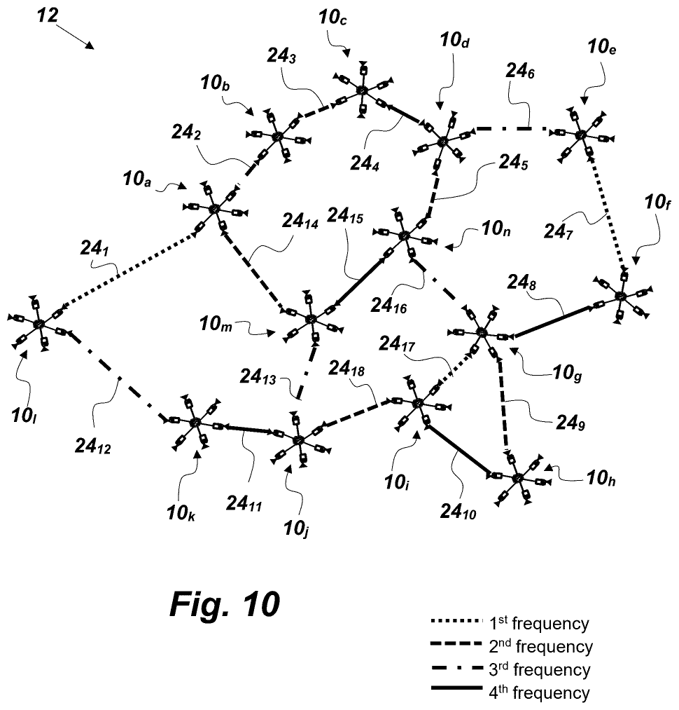

FIG. 10 is a diagram of an embodiment of the MRNNA network 12 having fourteen network MRNNA nodes 10 and the quasi-dedicated links 24 between the MRNNA nodes 10 each operate at a different frequency. The quasi-dedicated links 24 from/to of a given MRNNA node 10 are at different frequencies (to minimize potential self-interference) within a given MRNNA node 10. However, because of spatial diversity, frequencies can be re-used in other quasi-dedicated links 24 of the MRNNA network 12. In the embodiment shown in FIG. 10, note that only four frequencies are required to support the entire network of fourteen MRNNA nodes (10ₐ-10ₙ). All the quasi-dedicated links 24 are able to operate at full speed due to spatial-reuse. Also note that in this embodiment, every MRNNA node 10 has at least two quasi-dedicated links 24. For example, MRNNA node 10ₐ has a quasi-dedicated link with MRNNA node 10_{b}, MRNNA node 10₁, and with MRNNA node 10ₘ (i.e., quasi-dedicated links 24₁, 24₂, and 24₁₄). It can be seen that MRNNA node 10_{g} has four separate quasi-dedicated links 24 (i.e., links 24₈, 24₉, 24₁₆, and 24₁₇) all using different frequencies. Accordingly, it should be appreciated that the embodiment of the MRNNA network 12 shown in FIG. 10 will remain fully connected in spite of the loss of any single link.

A side benefit of using MRNNA nodes 10 in the MRNNA network 12 is that wireless networks using directional beams (at all MRNNA nodes) can have 10,000 times higher signal strength than those that use omni antennas. In a free-space propagation environment, this translates to 100 times longer range. This means a 1.6 kilometer (1 mile) link with omni-directional antennas can become a 160-kilometer (100-mile) directional link (without increasing RF power or radio sensitivity). Wireless network links now extend up to the LOS limit. With a high altitude aircraft in a link, ranges can be several hundred miles long. Link budget calculations show that 483 km (300 mile) links air-to-air (or longer for higher flying aircraft) can be supported as can 241 km (150 mile) air-to-surface links.

A secondary benefit of enabling long range links in a DWN with MRNNA nodes 10 is that the need to resort to multi-hopping (a mainstay approach of a traditional DWNs with omni-directional antennas) can be dramatically reduced. Since multi-hopping in a self-interfering omni-DWN is a key reason that numeric scaling performance is so poor, this challenge is also substantially avoided with MRNNA method 32.

A MRNNA network 12 consisting of MRNNA nodes 10 will be far less susceptible to jamming influences (unintentional or otherwise) than networks made up of nodes that utilize omni-directional antennas. Omni-directional-antenna-based networks will need nodes to be 100 to 300 times closer to each other than to any jamming source. In comparison, wireless networks that use directional antennas such as the MRNNA network 12 can have 10,000 times higher signal strength links than omni-directional-antenna based networks. This makes the communications link's signal strength competitive with interference sources, even if the source of interference is relatively nearby. Narrow beam antenna's suppress the reception of interference in nearly all directions by a factor of 100 or more. Special network topology and routing that is aware of the locations of specific sources of interference can set up links that are in directions most favorable to the radios 14 and minimize the amount of interference that gets into the radios 14.

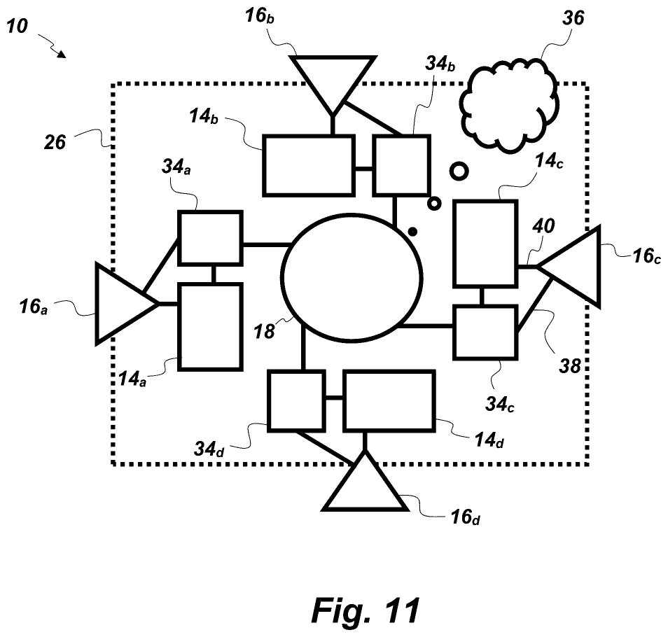

FIG. 11 is a schematic view of another embodiment of the MRNNA node 10, which generally is physically supported by a platform 26. In this embodiment, the directional antennas 16ₐ, 16_{b}, 16_{c}, and 16_{d}, are steerable antennas which are placed around the platform 26 and are respectively connected to sector embedded processors (i.e. computers) 34ₐ, 34_{b}, 34_{c}, and 34_{d} and to radios 14ₐ, 14_{b}, 14_{c}, and 14_{d}. The sector embedded processors 34ₐ, 34_{b}, 34_{c}, and 34_{d} are also connected to the master controller 18. In some embodiments, the sector embedded processors 34 may be part of the master controller (e.g., separate virtual machines running on the master controller). The master controller 18 may also be connected to other networks (i.e., networks outside the MRNNA network 12) represented by the cloud 36. The cloud 36 can include local area networks on or near the platform 26 or wider area networks for example the Internet. It should be understood that while sector embedded processors 34ₐ, 34_{b}, 34_{c}, and 34_{d} have been illustrated as distinct from radios 14ₐ, 14_{b}, 14_{c}, and 14_{d}, the sector embedded processors 34 may in fact be physically contained within the radios 14.

Still referring to FIG. 11, each sector embedded processor 34 in this embodiment is connected to its corresponding directional antenna 16 via a digital information transmission line 38 (e.g., capable of passing digital information in the form of ones and zeros) to control the beam pointing for the antenna. Each radio 14 is connected to its corresponding directional antenna 16 via an RF line 40 capable of transmitting RF signals. The preferred form of the digital information transmission line 38 will usually be copper assuming that the embedded processor to antenna distance is reasonably short (i.e. three meters or less). If the distance is significantly longer than three meters, the preferred form (especially in a highly RF energetic environment) may be optical fiber. The preferred form of digital information transmission line 38 between the sector embedded processor 36 and the master controller 18 will usually be optical fiber when the distances between the sector embedded processor 36 and the master controller 18 is in excess of twenty meters, which is the case for many applications (e.g., onboard a ship, building, a large airframe, etc.). However, if the distance is reasonably short, then the digital information transmission line 38 between the sector embedded processor 36 and the master controller 18 will typically be made of copper. In relatively-RF-benign environments, the preferred form of the digital information transmission line 38 between the sector embedded processor 36 and the master controller 18 may be no line at all. In other words, the connection between the sector embedded processor 36 and the master controller 18 may be made wirelessly (to save the effort and cost of installing a fiber or cable run).

Each sector embedded processor 36 may comprise a software module containing computer code responsible for the details of pointing each of the corresponding directional antennas 16. The software module understands the properties of the directional antenna 16 and is capable of steering its beams. Likewise the software module also understands the capabilities of the radio 14 and knows how to control it. By steering beams and receiving feedback from the radio 14 at each beam position, the sector embedded processor 36 is able to acquire basic information such as link state and RSSI for various beam positions. This forms the basis for neighbor discovery, RF tracking, and topology control algorithms. The master controller 18 collects link state information from all sector embedded processors 36 and makes topology control decisions about which links each sector 20 should manage. The master controller 18 may include a master controller embedded process (not explicitly shown in FIG. 11) which handles high level decisions for MRNNA node 10.

Each sector 20 of a given MRNNA node 10 may be configured to support communication on a single link at a time (on a time-scale of seconds or minutes). This helps avoid problems with some protocols that operate on millisecond scales. Using this framework, many different types of radios may be used. Experience has shown that nearly all radios provide the basic required feedback which is link state and RSSI in a more or less timely manner. In this way, a MRNNA network 12 can be broadly (though not universally) radio agnostic in that each MRNNA node 10 is able to by-pass MAC layer, QoS and other protocol problems typically associated with directional antennas. Consider a link between two radios with directional antennas that are pointing directly at each other 100% of the time. From the radio's point of view it is as if they are both using omni-directional antennas that are within range of each other. No ill effects at the MAC layer are observed. Outdoor demonstrations have proven that such a link can be maintained with high reliability in a multi-path mobile environment. In operation, as two MRNNA nodes 10 come within range/view of each other they will each quasi-dedicate one of their sectors 20 to maintain a link between those sectors 20. From that time forward, that pair of linked sectors will focus on tracking and maintaining the health of the quasi-dedicated link until either (1) the link can no longer be maintained due to excessive distance or intervening line of sight blockage or other reasons; or (2) the master controller 18 calculates a network topology update, and the new topology calls for different sets of quasi-dedicated links to be established between the various sectors 20 on the various MRNNA nodes 10. The afore-mentioned topology change may occur in the MRNNA network 12 as at least some of the MRNNA nodes 10 are often in motion. Even if none of the MRNNA nodes 10 in the MRNNA network 12 change their locations or orientations (rotations), the RF environment can change and thereby necessitate a topology change. This can be especially true for a wireless network that is trying to operate in the presence of interfering RF sources. As each MRNNA node 10 has multiple radios 14, it will have other sectors 20 available to discover and create additional quasi-dedicated links 24 with other/neighboring MRNNA nodes 10. In this fashion, network topologies are created out of quasi-dedicated links 24.

The simplicity of the MRNNA design and approach is quite powerful. The focus moves away from the challenging problem of protocol modification and on to the creation and maintenance of stable links. Topology management becomes the glue that holds the network together and current MAC, routing, and QoS protocols may be used effectively rather than fought against. That said, mobility has an unavoidable effect on link management and topology control. Link maintenance, or “tracking” without the aid of a global satellite navigation system is a difficult problem that exists in all DWNs; a problem that becomes more complex when one tries to solve it at the MAC layer. The MRNNA approach (exemplified by MRNNA network 12 and MRNNA method 32) allows one to focus on the tracking problem to better maintain stable links. Network protocols still must be able to adapt to changing topologies. However, maintaining stable quasi-dedicated links is much less disruptive than the chaos observed when each node points its beams in different directions over short (sub-second) time scales and surrounding protocol layers that are unaware of this try to adapt to the physical-layer-induced changes.

Operational uses of MRNNA nodes 10 and MRNNA method 32 include, but are not limited to, ship-to-ship, ship-to-shore, ship-to-air, air-to-air, ground-to-ground and ground-to-air communications. The distances and velocities between MRNNA nodes 10 are such that relative angles between them do not change rapidly. Relative angles are dominated by the local rotation of each MRNNA node 10. With MRNNA method 32 and the MRNNA network 12, neighbor discovery, tracking capabilities and topology control take center stage. With MRNNA method 32, we have experimentally demonstrated purely RF based tracking and topology control that supports local rotational rates of greater than 1500 degrees per minute. This rate of RF tracking is more than sufficient to support ship movements, ground vehicle movements and most aircraft maneuvers.

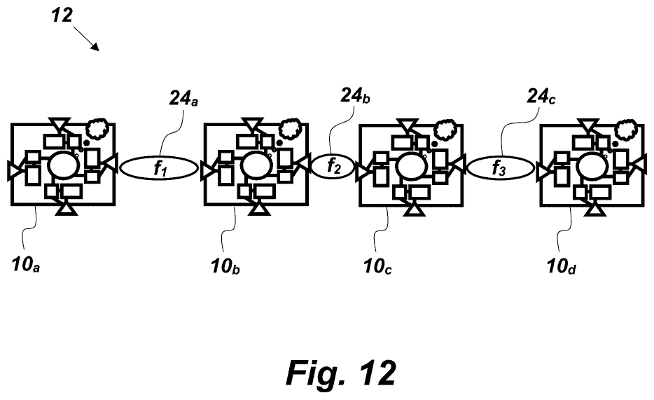

FIG. 12 is an illustration of an embodiment of the MRNNA network 12 with four MRNNA nodes 10 with locations that are approximately along a line. Use of MRNNA method 32 delivers many performance benefits in addition to those already mentioned such as reduced latency and greater total network throughput as additional side benefits of using multiple radios 14 per MRNNA node 10. This stems from the fact that multiple radios allow a MRNNA node 10 to transmit/receive concurrently in different directions with other MRNNA nodes 10 in the MRNNA network 12. To eliminate possible interference, one will typically set co-linear radio links to different frequencies as shown in FIG. 12. By transmitting and receiving concurrently, no delays are required to mediate channel access and a steady stream of packets may be sent across multiple hops. This approach avoids latency build up that would otherwise occur with competing approaches that require data buffering at each hop (to allow time for single radios per node systems to “take in” and then “send out” packets of data). FIG. 12 shows an example of how the MRNNA network 12 and MRNNA method 32 may be used to minimize latency and maximize total network throughput in a multi-hop relay network. The locations of the MRNNA nodes 10 in this embodiment, result in co-linear radio links 24ₐ, 24_{b}, and 24_{c}. To minimize both interference and latency, the master controllers 18 may determine a set of frequencies for each of the quasi-dedicated links 24 such that the operating frequency of each of the quasi-dedicated links 24ₐ, 24_{b}, and 24_{c} is different.

A designated frequency may be used by the MRNNA nodes 10 when actively seeking for neighbor MRNNA nodes 10. When two MRNNA nodes 10 discover each other, they may be configured to share with each other information including node-specific lists of which frequencies are being used by the respective sectors 20 of each MRNNA node 10 and which frequencies are available for establishing a new quasi-dedicated link 24 between the two MRNNA nodes 10. After that information is shared, the first available frequency that appears on both node-specific lists may be selected as the operating frequency for a new quasi-dedicated link 24 by the respective master controllers 18 of the two MRNNA nodes 10. Then, both master controllers 18 follow a count-down procedure to switch two designated sectors 20 (one from each of the two MRNNA nodes 10) to the selected frequency at the same time (so that communication between the two MRNNA nodes 10 is not lost). Alternatively, the MRNNA nodes 10 may be configured to assign frequencies to the various quasi-dedicated links 24 using an edge coloring algorithm, which may require other nodes in the network to switch frequencies of other quasi-dedicated links 24 as well. Each master controller 18 may be configured to assign its sectors 20 to track specific links 24. Due to spatial reuse and/or frequency management, sectors 20 in a MRNNA node 10 may transmit concurrently which provides performance benefits in terms of maximizing throughput and minimizing delay.

The MRNNA node 10 is not limited to the configurations shown in figures, but other variations are possible, such as additional antennas, and correspondingly smaller sector ratios (e.g., six antennas and 60 degree sectors). Other variations are possible as well, such as eight antennas with 45 degree non-overlapping sectors, or eight antennas with 90 degree sectors where pairs of antennas completely overlap with regard to the coverages of their sectors.

From the above description of the MRNNA node, network, and method, it is manifest that various techniques may be used for implementing the concepts of the MRNNA node, network, and method, without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that the MRNNA node, network, and method, are not limited to the particular embodiments described herein, but are capable of many embodiments without departing from the scope of the claims.

We claim:

1. A wireless mesh network node comprising:
a plurality of radios mounted on a platform, wherein each of the plurality of radios is a complete, stand-alone, unmodified radio lacking only an antenna;
a plurality of directional antennas mounted on the platform, wherein each of the plurality of antennas is communicatively connected to a corresponding radio of the plurality of radios, wherein a combination of an antenna and its corresponding radio is referred to as a sector; and
a master controller mounted to the platform and operatively connected to the sectors, wherein the wireless mesh network node is configured to discover remote neighbor nodes by having each sector perform a zone-limited search of a surrounding area without the use of an omnidirectional or broadbeam antenna, and wherein the master controller is configured to receive, from the sectors, link-state information and geo-location information of the remote neighbor nodes.

2. The wireless mesh network node of claim 1, wherein each radio uses an unmodified, original media access control (MAC) protocol associated with each radio.

3. The wireless mesh network node of claim 2, wherein each remote neighbor node is mounted to a separate, corresponding remote platform and has the same structure as the wireless mesh network node of claim 2.

4. The wireless network node of claim 3, further comprising: an RF switch mounted to the platform and communicatively coupled between the plurality of radios and the plurality of directional antennas such that the RF switch is capable of dynamically controlling which radio is connected to which directional antenna, wherein the master controller is configured to determine a given radio, a given directional antenna, and a given frequency to be used for communicating with a given remote neighbor node.

5. The wireless network node of claim 4, wherein the plurality of radios consists of four radios and the plurality of directional antennas consists of four directional antennas mounted circumferentially to the platform in a plane that is orthogonal to a gravity vector, and wherein the four directional antennas are spaced apart from each other on the platform.

6. The wireless network node of claim 4, wherein the plurality of radios consists of six radios and the plurality of directional antennas consists of six directional antennas mounted circumferentially to the platform in a plane that is orthogonal to a gravity vector, and wherein the six directional antennas are spaced apart from each other on the platform.

7. The wireless network node of claim 6, wherein each of the sectors transmits and receives on a different frequency from the other sectors on the wireless network node as dynamically determined by the master controller thereby allowing concurrent communication between the wireless network node and several of the remote neighbor nodes.

8. The wireless network node of claim 7, wherein the directional antennas are narrow beam, high gain, directional antennas.

9. The wireless mesh network node of claim 2, wherein each directional antenna is an electronically steerable antenna with a beamwidth of less than twenty degrees, and wherein the zone-limited search of the surrounding area involves each sector searching a separate corresponding zone.

10. The wireless mesh network node of claim 8, wherein the master controller is configured to establish a quasi-dedicated point-to-point link between a pair of sectors when channel conditions are favorable for successful transmission and reception between the pair of sectors, wherein the pair of sectors consists of a first sector from the wireless mesh network node and a second sector from a discovered remote neighbor node, and wherein while the quasi-dedicated point-to-point link is established, the first and second sectors are not linked to any other sectors.

11. The wireless mesh network node of claim 10, wherein once the quasi-dedicated point-to-point link is established between the pair of sectors, the master controller is configured to maintain the quasi-dedicated point-to-point link for at least one second such that the master controller does not need to coordinate beam steering operations with routing, quality of service, and MAC protocols.

12. The wireless mesh network node of claim 11, wherein the master controller is configured to establish the quasi-dedicated point-to-point link between the pair of sectors for at least sixty seconds.

13. The wireless mesh network node of claim 12, wherein there is a one-to-one relationship between the paired sectors that is achieved by isolating the paired sectors from the rest of the wireless mesh network using frequency assignment, antenna pointing direction, and data link layer configuration.

14. A method for establishing a wireless mesh network comprising:
providing a plurality of nodes, wherein each node comprises N sectors communicatively connected to a node-specific master controller, wherein each sector comprises a radio connected to a directional antenna;
discovering, with each sector, without the use of an omnidirectional or broadbeam antenna, remote sectors from remote neighbor nodes that are in view of each sector's associated directional antenna;
receiving at each given node, from the given node's sectors, link-state information and geo-location information of the remote neighbor nodes;
calculating at each node a topology of the wireless mesh network based on the link-state information and geo-location information;
determining, based on the topology and a predefined ruleset, a pair of sectors to establish a quasi-dedicated link between, wherein the sectors in the pair of sectors are mounted to different platforms; and
establishing and maintaining a quasi-dedicated link between the pair of sectors for at least sixty seconds.

15. The method of claim 14, further comprising continuing to discover remote neighbor nodes with the sectors that are not part of the quasi-dedicated link.

16. The method of claim 15, further comprising dynamically determining, with the node-specific master controller for each node, a frequency for transmitting and receiving at each sector of each node thereby enabling concurrent communication between a single node and multiple other remote neighbor nodes.

17. The method of claim 16, wherein the discovering step is performed with high gain, narrow beams to spatially re-use frequencies.

18. The method of claim 14, wherein each node further comprises an RF switch communicatively coupled between each node's master controller and sectors, and further comprising:
dynamically controlling, with the node-specific master controller of a given node, which radio is connected to which directional antenna for the given node; and
determining, with the node-specific master controller of the given node, a given radio, a given directional antenna, and a given frequency to be used for communicating with a given sector of a given remote neighbor node.

19. The method of claim 18, wherein N equals six, and wherein the directional antennas for each node are mounted circumferentially to a corresponding platform.

20. The method of claim 19, further comprising isolating the pair of sectors from the rest of the wireless mesh network using frequency assignment, antenna pointing direction, and data link layer configuration so as to create a one-to-one relationship between the pair of sectors that is not shared with any other sectors in the wireless mesh network.
